(19) United States
(12) Patent Application Publication
(10) Pub. No.: US 2006/0054391 A1
(43) Pub. Date: Mar. 16, 2006

(54) Standoff attachment and ladder

(76) Inventor: Jack H. Tilley, Ball Ground, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/222,539

(22) Filed: Sep. 9, 2005

Related U.S. Application Data
(60) Provisional application No. 60/608,337, filed on Sep. 9, 2004.

(51) Int. Cl. E06C 7/42

(52) U.S. Cl. 182/107

(57) ABSTRACT

A device for a ladder having two side rails with top and bottom ends and a plurality of rungs extending therebetween includes a standoff structure with a pivot foot. The standoff structure is mounted adjacent the top of the ladder and extends transversely from its side rails. Preferably, the standoff structure includes two arms having cross pieces extending therebeween, braces extending between the side rails and the standoff structure for bracing the standoff structure to the side rails, and a pivot foot secured adjacent distal ends of the standoff structure for engaging a surface and for pivotal motion relative to the arms. Preferably, the pivot foot has a resilient, slip-resistant face for engaging the surface. Thus, the ladder can be leaned against a house or other structure and the pivot foot can engage the house to brace the ladder while the rails of the ladder avoid contact with the house.

### CROSS-REFERENCE TO RELATED APPLICATIONS

The present application claims the priority benefit of U.S. provisional patent application Ser. No. 60/608,337, filed Sep. 9, 2004, and incorporates the disclosure of the same herein by reference.

### BACKGROUND OF THE INVENTION

Conventional ladders, such as extension ladders and non-extension ladders, typically are leaned against a wall or side of a house when in use. Some ladders manufactured today incorporate stabilizing devices attached to the top and/or bottom of the ladder to prevent the ladder from sliding off the wall. Most stabilizing devices located at the tops of the ladders have metal bars that extend out from the side rails of the ladder. These metal bars turn downwardly and rest against the wall, while incorporating a flat piece of plastic to protect the wall somewhat. Although these devices help to stabilize the ladder, the rails of the ladder remain in contact with the wall or side of the house.

However, when cleaning the gutters, positioning the ladder below the gutter against the side of the house or positioning the ladder against the gutter can be dangerous to the user. If the ladder is placed beneath the gutter, then the user would have to reach up and over the gutters to clean the gutters. By reaching over the gutters, the person risks becoming off-balance and falling.

Similarly, placing a ladder directed against a gutter can be dangerous to the user. Typically, gutters are made of thin extruded aluminum or some other relatively lightweight material. If the person on the ladder extends himself or herself too far off center of the ladder, a force vector could be created that would cause the ladder to slide sideways. Thus, the gutter would offer little or no resistance to ladder movement, which could easily cause a serious accident to the user. Moreover, as gutters are typically constructed of lightweight material, the force of the ladder resting against the house can damage them.

In other instances, roofers, when accessing a roof, tend to position the ladder against the gutter line such that three or four feet of the ladder extend above the roof line. Thus, roofers have to step off the ladder and onto the roof, while using the upper portion of the ladder as a support. When a roofer is stepping from the ladder to the roof, he is actually pushing against the ladder, and the ladder could easily shift side ways, which in turn can cause the roofer to fall.

Thus, it has been found that a need yet exists for an improved stabilizing device for a ladder, which device allows a user to access gutters or a roof safely while the rails of the ladder to avoid contact with a gutter or a side of the house. It is to the provision of such an improved stabilizing device for a ladder meeting these and other needs that the present invention is primarily directed.

### SUMMARY OF THE INVENTION

Briefly described, in an illustrative form the present invention comprises a ladder apparatus having a pair of side rails having top ends and bottom ends and a plurality of rungs extending therebetween. The ladder apparatus also includes a standoff assembly mounted to the top of the ladder and extending transversely from the side rails. The standoff assembly preferably includes a pair of arms having cross pieces extending therebetween, first and second braces extending between the side rails and the standoff assembly for bracing the standoff assembly to the side rails, and a pivot foot secured adjacent distal ends of the standoff assembly for engaging a surface. The pivot foot has a resilient face for engaging the surface and to help resist slipping, which allows the resilient face to confront the surface over a range of angular orientations of the arms of the standoff assembly relative to the surface. Preferably, the resilient face is non-marring and slip-resistant and has a length longer than the distance between the two side rails. Also preferably, the combination of one arm, one brace, and one rail of the ladder form a rigid truss.

In another form, the present invention comprises a ladder for leaning against a house or other structure. The ladder has a pair of side rails having top ends and bottom ends and a plurality of rungs extending therebetween, a standoff structure mounted adjacent the top ends of the rails of the ladder and extending transversely thereto, and a pivot foot pivotally mounted adjacent a distal end of the standoff structure for engaging a surface of the house or other structure. Thus, the ladder can be leaned against a house or other structure and the pivot foot can engage the house to brace the ladder while the rails of the ladder are held away from the house and avoid contact with the house. Optionally, the standoff structure is pivotally mounted to the top ends of the rails. Preferably, the pivot foot has a resilient, non-marring, and slip-resistant face plate for engaging the surface.

In still another form, the present invention comprises an attachment for use with a ladder of the type to be leaned against a house other structure, the ladder having a pair of side rails having top ends and bottom ends. The attachment includes a standoff structure mounted to the top of the ladder and extending transversely from the side rails, at least one brace extending between a side rail and the standoff structure for bracing the rail of the standoff structure to the ladder, and a foot secured adjacent a distal end of the standoff structure and having a resilient face plate for engaging a roof or top of a building or other structure. Preferably, the attachment is a rigid structure having a length longer than the distance between the two side rails.

Advantageously, the device of the present invention provides a more stable and safer ladder such as for cleaning the gutters or climbing onto the roof of the building. It is envisioned that the stabilizing device of the present invention is an attachment for existing ladders, although the present invention encompasses ladders modified to include the stabilizing device as an integral component. The device provides a standoff structure with a pivot foot at its distal end. Thus, the pivot foot engages the roof and prevents the ladder from sliding sideways, while the rails of the ladder do not touch the gutter or the side of the house. The device can be made integral with the ladder, or the device can be mounted to an existing ladder. Moreover, the device can be adjusted to accommodate various roof angles.

### BRIEF DESCRIPTION OF THE DRAWINGS

FIG. 1 is a side view of a ladder with a stabilizing device attached to an upper portion thereof in accordance with an illustrative form of the present invention and shown positioned against a roof of a house.

FIG. 2 is a perspective view of a portion of the stabilizing device of FIG. 1.

FIG. 3 is a sectional view of a mounting assembly portion of the stabilizing device of FIG. 1.

### DETAILED DESCRIPTION OF THE INVENTION

The present invention may be understood more readily by reference to the following detailed description of the invention taken in conjunction with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

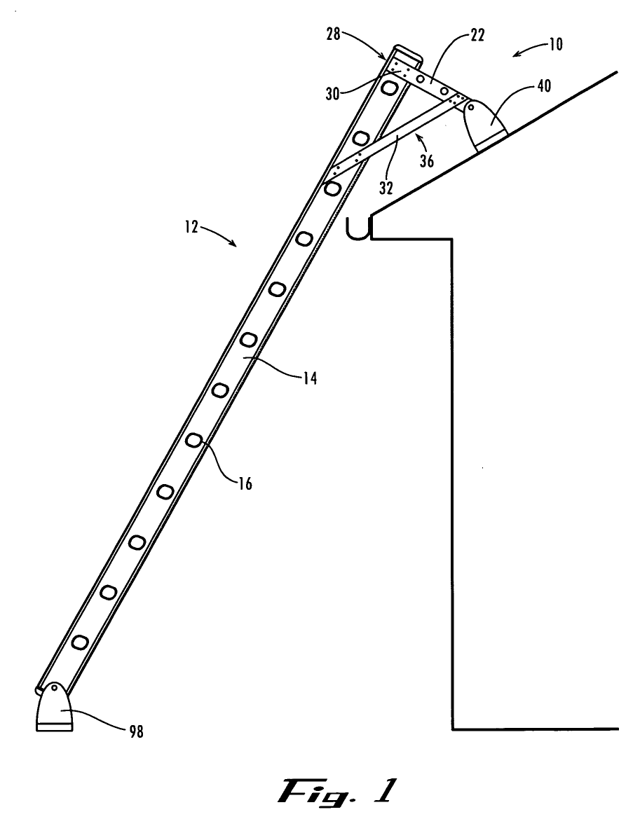

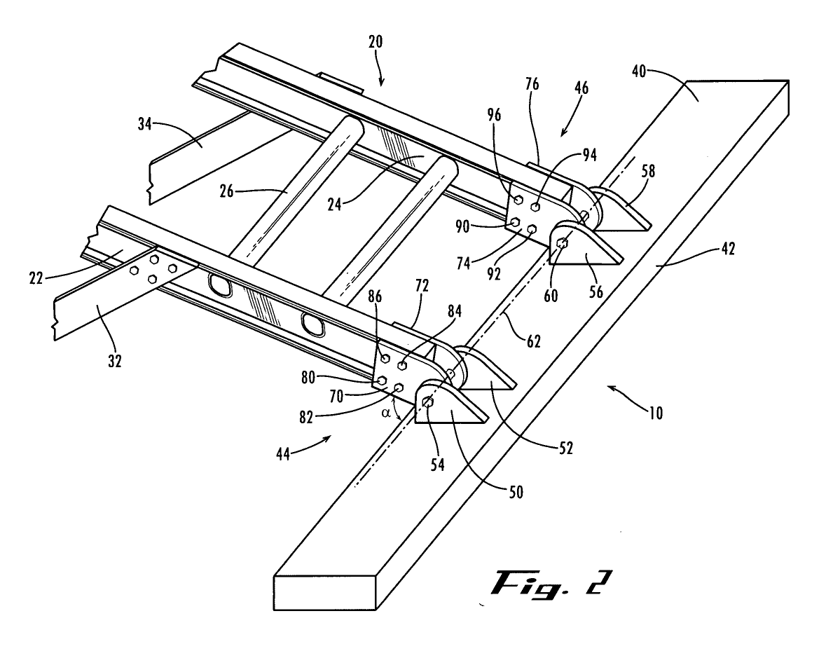

FIGS. 1, 2, and 3 depict an attachment or stabilizing device 10 for use with a ladder 12, such as a standard aluminum extension ladder or a standard non-extension ladder. The ladder 12 has a pair of parallel side rails 14, with a plurality of rungs 16 extending therebetween. In standard aluminum ladders, each rail 14 typically is extruded into a “C”-shaped channel for strength and rigidity. Although the present invention is described herein in terms of use with a conventional aluminum ladder, those skilled in the art will understand that the stabilizing device 10 can be adapted to other types of ladders.

The stabilizing device 10 includes a standoff structure or assembly 20 mounted to the top of the ladder 12 and extending transversely from the side rails 14. The standoff structure 20 includes a pair of arms or standoff rails 22 and 24 having crosspieces 26 extending therebetween. Each arm 22 and 24 can be constructed of lightweight aluminum and extruded into a “C”-shaped channel for strength and rigidity. Preferably, the arms 22 and 24 are constructed of a lightweight material so that the ladder 12 can be easily moved around; however, those skilled in the art will understand that various other materials can be employed as well. The pair of arms 22 and 24 can be permanently or semi-permanently mounted to shoulder portions 28 of the ladder with one or more bolts, as seen in the figures, or the arms can be pivotally secured to the rails so that they rotate about the shoulder portions. However, those skilled in the art will appreciate that other fasteners, of various shapes, sizes, and number, and fastening methods can be used without departing from the scope of the present invention. Optionally, the standoff structure 20 includes a pair of mounting brackets 30 for mounting the arms 22 and 24 to the tops of the rails 14. Preferably, the arms 22 and 24 are about three feet to four feet in length, although those skilled in the art will understand that arms of various other shapes, sizes, materials, and lengths can be employed as well. Alternatively, a single arm or more than two arms can also be employed.

A pair of braces 32 and 34 extend between the side rails and the standoff structure 20 for bracing the side arms 22 and 24 of the standoff structure to the rails 14 of the ladder. The braces 32 and 34 can be permanently fixed to the rails of the ladder 12, or the braces can be adjustably fixed to the rails of the ladder. If the arms 22 and 24 and the braces 32 and 34 are permanently or semi-permanently affixed to the rails of the ladder, then the arm 22, brace 32, and one rail of the ladder form a rigid truss 36, while the other arm, brace, and rail form a second rigid truss. Or, the rails of the ladder 12 can have plurality of openings therein such that the braces 32 and 34 can be adjustably connected to the rails at various points along the length of the rails. A wing nut can be used to secure the brace to the rail. Thus, the height and angle of the stabilizing device 10 relative to the roof can be adjusted to accommodate the slope or pitch of the roof or other structure to be engaged.

The stabilizing device 10 further includes a foot or pivot member 40 adjacent the distal ends of the arms 22 and 24 of the standoff structure 20 for engaging a surface. Preferably, the foot 40 is pivotally mounted to the arms 22 and 24 of the standoff structure 20 for pivotal motion relative to the arms. The foot 40 can be constructed of metal, wood, or another rigid and resilient material. The front of the foot 40 has a face plate or gripping element 42 affixed thereto. Preferably, the gripping element 42 is formed of a resilient, non-marring, and slip-resistant material, such as a soft rubber, although various other resilient, slip-resistant, and non-marring materials can be employed as well. Additionally, the gripping element 42 can be smooth, nubbly, or can have a tread pattern cut into its surface to better grip the vertical surface.

Preferably, the foot 40 has a length about twice that of the distance between the rails 14 of the ladder 12 so as to cover a larger area and further stabilize the ladder. Optionally, the foot 40 can include a pair of outriggers to extend the length of the foot. Alternatively, the widths of the standoff structure 20 and the foot 40 are about the same width as the ladder 12 so that the stabilizing device 10 does not interfere with the transport and storage of the ladder.

Preferably, the stabilizing device also includes a pair of mounting assemblies 44 and 46 for mounting the foot 40 to the arms 22 and 24. The mounting assembly 44 includes a pair of pivot plates or swing arms 50 and 52 and a pivot axle 54, while the mounting assembly 46 includes similar pivot plates or swing arms 56 and 58 and a pivot axle 60. The pivot plates 50, 52, 56, and 58 are secured to the rear of the foot 40 and can be permanently affixed thereto. In the depicted embodiment, the pivot plates 50, 52, 56, and 58 are semicircular in shape, although other pivot plates of various shapes and sizes can be employed as well. Preferably, the pivot plates 50, 52, 56, and 58 are constructed of a rigid and resilient material, such as metal, although other materials can be employed as well. Each pivot plate has an opening therethrough for receiving a pivot axle.

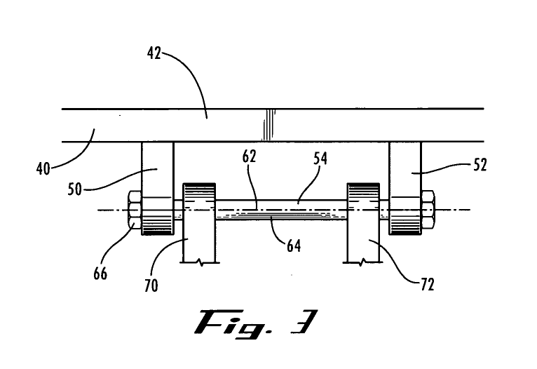

Thus, the plates 50 and 52 can pivot about the axle 54, while the plates 56 and 58 can pivot about the axle 60. Preferably, the openings of the pivot plates are all aligned such that the lengths of the pivot axles, when inserted therethrough, define a pivot axis 62. In the exemplary embodiment, the pivot axles 54 and 60 are each a bolt having a smooth shank and a threaded end portion. As seen more clearly in FIG. 3, which shows a cross-sectional view of the mounting assembly 44, the axle 54 has a smooth shank 64 with a threaded end portion (not shown) for receiving a nut 66, which is threaded onto the bolt. Similarly, although not shown in figures, the axle 60 has a smooth shank with a threaded end portion for receiving a nut to hold the bolt in place. In an alternate embodiment, a single pivot axle can be inserted through the openings of the four pivot plates so that the foot 40 can pivot about the pivot axis 62.

The mounting assembly 44 also includes a pair of arm or mounting bolsters 70 and 72, while the mounting assembly 46 also includes a pair of rail or mounting bolsters 74 and 76. The arm bolsters 70, 72, 74, and 76 reinforce the connection between the foot 40 and the arms 22 and 24 of the standoff structure 20. The arm bolsters 70, 72, 74, and 76 are adapted to be mounted to both the inside and outside of the arms 22 and 24, respectively, to couple the foot 40 to the standoff structure 20. Alternatively, a single arm bolster can be used for each rail such that the arm bolsters 70 and 74 could be mounted to either the inside or the outside of the arms 22 and 24, respectively, or the arm bolsters could be entirely omitted. In such an embodiment, the pivot axles 54 and 60 could be inserted through holes drilled directly in the arms 22 and 24. Preferably, the arm bolsters 70, 72 and 74, 76 are shaped to match and closely abut the arms 22 and 24. In the depicted embodiment, the arm bolsters 70, 72 and 74, 76 are flat, but in alternate embodiments, the arm bolsters can follow the contours of the arms 22 and 24. In the depicted embodiment, the arm bolsters 70, 72 and 74, 76 have a plurality of openings extending therethrough for insertion of fasteners. As shown in the figures, the fasteners are four bolts 80, 82, 84, 86 and 90, 92, 94, 96 that are used for each pair of arm bolsters 70, 72 and 74, 76, respectively. However, those skilled in the art will appreciate that other fasteners, of various shapes, sizes, and number, and fastening methods can be used without departing from the scope of the present invention.

Thus, when the stabilizing device 10 is attached to the ladder 12, the pivot foot 40 of the stabilizing device can pivot about the pivot axles 54 and 60 at an angle α relative to the arms 22 and 24 such that the resilient face 42 of the stabilizng device can rest flush against the roof regardless of the angle between the ladder and the ground (or floor). In other words, the pivot foot 40 allows the resilient face 42 to confront the surface over a range of angular orientations of the arms 42 and 44 relative to the surface.

Typically, there is a range of optimal angles between the ladder and the ground when a ladder is placed for use against a house. A ladder placed against a house or other structure is generally upright, but not completely vertical, which could be easily kicked over. Similarly, if the base of the ladder is too far from the house, the ladder becomes more difficult to climb. Thus, the stabilizing device of the present invention can have a fixed angle relative to the rails of the ladder such that the pivot foot 40 pivots to accommodate roofs of different slopes or pitches. Alternatively or additionally, the angle of the stabilizing device relative to the rails can also be adjusted to accommodate various slopes or pitches of roofs.

Optionally, the ladder 12 can include a pair of swivel feet 98 or a pair of extenders at the lower ends of the rails 14 for added stability.

To attach the stabilizing device 10 to the ladder 12 (or any standard ladder), the user attaches the arms of the standoff structure to the rails of the ladder. The user can drill holes in the rails 14 of the ladder 12 such that the drilled holes align with the openings the arms. Preferably, any existing plastic pieces attached to the ends of the rails are removed prior to attaching the stabilizing device 10. Also preferably, any paint or other debris that would interfere with the mounting of the arms 22 and 24 is removed. At least one fastener and preferably a plurality of fasteners, such as bolts are inserted through the openings and are secured with a nut. As configured, the stabilizing device 10 can be attached to an upper end of the ladder 12 so that the stabilizing device, rather than the ladder itself, contacts and engages a surface such as a roof of a house, while the rails of the ladder avoid contact with the house. Moreover, the foot 40 better grips and protects the surface of the roof by resting flat against the contour of the roof. Thus, a ladder with the stabilizing device 10 is configured to extend about three to four feet above the gutter line. This allows users to easily clean gutters, as well providing safe access to the roof. Additionally, the ladder stabilizing device of the present invention can be used by roofers because the stabilizing device rests firmly on the roof. Thus, the ladder is not resting against the gutter, and the ladder is much less likely to shift.

While the invention has been described with reference to preferred and exemplary embodiments, it will be understood by those skilled in the art that a variety of modifications, additions and deletions are within the scope of the invention, as defined by the following claims.

1. A ladder apparatus, comprising:
a pair of side rails having top ends and bottom ends and a plurality of rungs extending therebetween; and
a standoff assembly mounted to the top of the ladder and extending transversely from the side rails, wherein the standoff assembly includes:
a pair of arms;
first and second braces extending between the side rails and the standoff assembly for bracing the standoff assembly to the side rails; and
a pivot foot secured adjacent distal ends of the standoff assembly for engaging a surface and for pivotal motion relative to the arms, the pivot foot having a resilient face for engaging the surface and to help resist slipping, and the pivot foot allowing the resilient face to confront the surface over a range of angular orientations of the arms of the standoff assembly relative to the surface.

2. The ladder apparatus of claim 1, wherein one arm, one brace, and one rail of the ladder form a rigid truss.

3. The ladder apparatus of claim 1, wherein the resilient face has a length longer than the distance between the two side rails.

4. The ladder apparatus of claim 1, wherein the arms have a length of about three to about four feet.

5. The apparatus of claim 1, wherein the resilient face is non-marring and slip-resistant.

6. The apparatus of claim 1, wherein the pair of arms have cross pieces extending therebetween.

7. A ladder for leaning against a house or other structure, comprising:
a pair of side rails having top ends and bottom ends and a plurality of rungs extending therebetween;
a standoff structure mounted adjacent the top ends of the rails of the ladder and extending transversely thereto; and
a pivot foot pivotally mounted adjacent a distal end of the standoff structure for engaging a surface of the house or other structure, whereby the ladder can be leaned against a house or other structure and the pivot foot can engage the house to brace the ladder while the rails of the ladder avoid contact with the house.

8. The ladder of claim 7, wherein the standoff structure is pivotally mounted to the top ends of the rails.

9. The ladder of claim 7, wherein the pivot foot has a resilient face plate for engaging the surface.

10. The ladder of claim 9, wherein the face plate is non-marring and slip-resistant.

11. The ladder of claim 7, further comprising a brace extending between the side rail and the standoff structure for bracing the standoff structure to the side rail of the ladder.

12. The ladder of claim 7, wherein the standoff structure has a pair of arms extending from the top ends of the rails of the ladder.

13. The ladder of claim 12, further comprising a mounting assembly for coupling the standoff structure to the rails of the ladder.

14. An attachment for use with a ladder of the type to be leaned against a house other structure and having a pair of side rails having top ends and bottom ends, the attachment comprising:
a standoff structure mounted to the top of the ladder and extending transversely from the side rails;
at least one brace extending between the side rail and the standoff structure for bracing an arm of the standoff structure to the rail of the ladder; and
a foot secured adjacent a distal end of the standoff structure and having a resilient face plate for engaging a roof or top of a building or other structure.

15. The attachment of claim 14, wherein the attachment is a rigid structure having a length longer than the distance between the two side rails.

16. The attachment of claim 14, wherein the standoff structure further comprises a mounting assembly for mounting the standoff structure to the tops of the rails.

17. The attachment of claim 14, wherein the resilient face plate has a surface for gripping the roof or top of a building or other structure.

18. The attachment of claim 17, wherein the surface of the face plate is non-marring and slip-resistant.

19. The attachment of claim 14, wherein the standoff structure further includes a pair arms mounted to the tops of the rails of the ladder.

20. The attachment of claim 19, wherein the standoff structure further includes a pair arms pivotally connected to the tops of the rails.
